(19) United States
(12) Patent Application Publication
(10) Pub. No.: US 2025/0187568 A1
(43) Pub. Date: Jun. 12, 2025

(54) VEHICLE CONTROL DEVICE

(71) Applicant: TOYOTA JIDOSHA KABUSHIKI KAISHA, Toyota-shi (JP)

(72) Inventor: Takeo MIKI, Susono-shi (JP)

(73) Assignee: TOYOTA JIDOSHA KABUSHIKI KAISHA, Toyota-shi (JP)

(21) Appl. No.: 18/826,437

(22) Filed: Sep. 6, 2024

(30) Foreign Application Priority Data
Dec. 12, 2023 (JP) 2023-208989

(51) Int. Cl. B60T 7/14

(52) U.S. Cl. CPC B60T 7/14

(57) ABSTRACT

A vehicle control device includes: an automatic brake control unit that performs automatic brake control for automatically stopping a host vehicle by applying a braking force to the host vehicle; a stop holding control unit that performs stop holding control for holding the host vehicle in a stopped state by applying a braking force to the host vehicle in a state of being stopped by the automatic brake control unit; a stop holding cancellation control unit that cancels a stop holding state of the host vehicle by terminating the stop holding control when a predetermined stop holding cancellation condition is met when the stop holding control is performed; and a driver status acquisition unit that acquires a driver status that is a status of a driver of the host vehicle. The stop holding cancellation control unit changes the stop holding cancellation condition according to the driver status.

### CROSS-REFERENCE TO RELATED APPLICATION

This application claims priority to Japanese Patent Application No. 2023-208989 filed on Dec. 12, 2023, incorporated herein by reference in its entirety.

### BACKGROUND

### 1. Technical Field

The present disclosure relates to a vehicle control device.

### 2. Description of Related Art

For example, Japanese Unexamined Patent Application Publication No. 2021-109504 discloses a device that performs stop holding control to stop a vehicle with an automatic brake and hold the stopped vehicle in a stopped state, and terminates the stop holding control and cancels the stop holding state of the vehicle when a predetermined time has elapsed since the start of the stop holding control.

### SUMMARY

If the stop holding control is uniformly terminated when a predetermined time has elapsed since the start of the stop holding control, secondary damage may occur due to the cancellation of the stop holding when the driver of the vehicle is not able to properly perceive surrounding information.

The present disclosure has been made to solve the above problem. That is, one object of the present disclosure is to effectively reduce the risk of occurrence of secondary damage due to the cancellation of stop holding.

A vehicle control device of the present disclosure includes: an automatic brake unit that performs automatic brake control for automatically stopping a host vehicle by applying a braking force to the host vehicle when it is determined that a predetermined automatic stop condition is met; a stop holding unit that performs stop holding control for holding the host vehicle in a stopped state by applying a braking force to the host vehicle so that the host vehicle in a state of being stopped by the automatic brake unit does not advance or reverse; a stop holding cancellation unit that cancels a stop holding state of the host vehicle by terminating the stop holding control when a predetermined stop holding cancellation condition is met when the stop holding control is performed by the stop holding unit; and a driver status acquisition unit that acquires a driver status that is a status of a driver of the host vehicle. The stop holding cancellation unit changes the stop holding cancellation condition according to the driver status acquired by the driver status acquisition unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a hardware configuration of a vehicle according to the present embodiment;

FIG. 2 is a schematic diagram illustrating a software configuration of a control device according to the present embodiment; and

FIG. 3 is a flow diagram for explaining a routine of stop holding control and a cancellation process for the stop holding control, executed by the control device according to the present embodiment.

### DETAILED DESCRIPTION OF EMBODIMENTS

Hereinafter, a vehicle control device according to the present embodiment will be described with reference to the drawings.

### Hardware Configuration

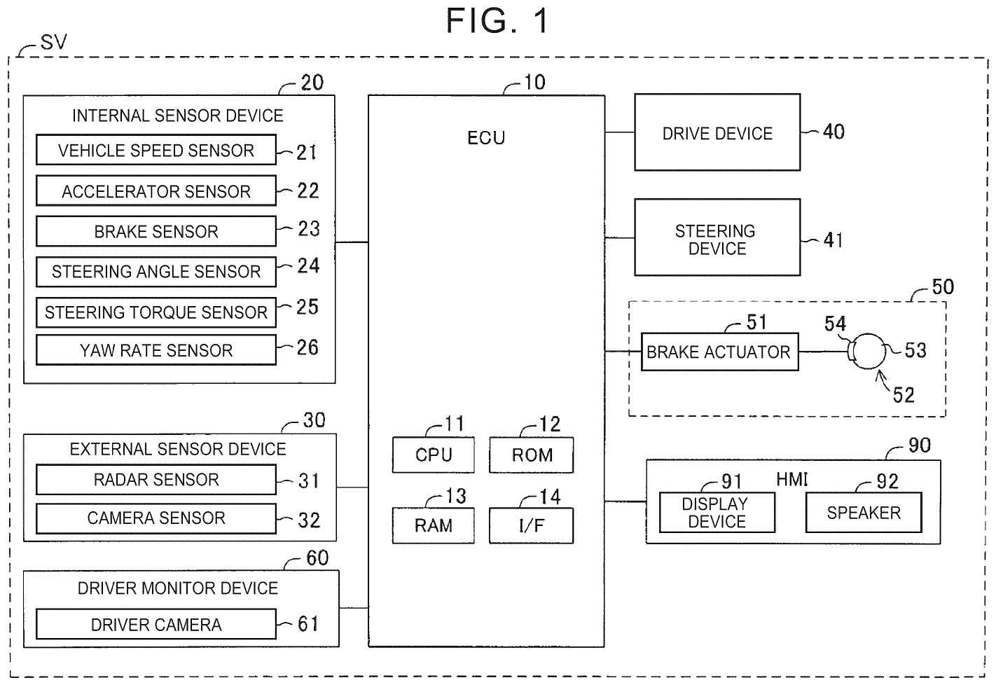

FIG. 1 is a schematic diagram illustrating a hardware configuration of a vehicle SV according to the present embodiment. Hereinafter, vehicle SV may be referred to as the host vehicle when distinction from other vehicles or the like is required.

The vehicle SV includes an electronic control unit (ECU) 10. The ECU 10 includes a central processing unit (CPU) 11, a read-only memory (ROM) 12, a random-access memory (RAM) 13, and an interface device 14, and the like. The CPU 11 is a processor that executes various programs stored in the ROM 12. The ROM 12 is a nonvolatile memory and stores data and the like necessary for the CPU 11 to execute various programs. The RAM 13 is a volatile memory and provides a work area where various programs are deployed when executed by CPU 11. The interface device 14 is a communication device for communicating with an external device.

The ECU 10 is a central device that performs driving support such as collision avoidance control (Pre-Crash Safety control: hereinafter referred to as PCS control). The driving support is a concept that includes autonomous driving. An internal sensor device 20, an external sensor device 30, a drive device 40, a steering device 41, a brake device 50, a driver monitor device 60, and a human-machine interface (HMI) 90 are communicatively connected to the ECU 10.

The internal sensor device 20 is a set of sensors that acquire the state of the vehicle SV. The internal sensor device 20 includes a vehicle speed sensor 21, an accelerator sensor 22, a brake sensor 23, a steering angle sensor 24, a steering torque sensor 25, a yaw rate sensor 26, and the like.

The vehicle speed sensor 21 detects the traveling speed (vehicle speed V) of the vehicle SV. The accelerator sensor 22 detects the amount of operation of an accelerator pedal (not illustrated) by the driver. The brake sensor 23 detects the amount of operation of a brake pedal (not illustrated) by the driver. The steering angle sensor 24 detects the angle of rotation (steering angle) of a steering wheel or steering shaft (not illustrated). The steering torque sensor 25 detects the rotational torque (steering torque) of the steering wheel or steering shaft (not illustrated). The yaw rate sensor 26 detects the yaw rate of the vehicle SV. The internal sensor device 20 transmits the state of the vehicle SV detected by each of sensors 21 to 26 to the ECU 10 at a predetermined cycle.

The external sensor device 30 is a set of sensors that recognize target information related to targets around the vehicle SV. The external sensor device 30 includes a radar sensor 31, a camera sensor 32, and the like. Here, examples of the targets include surrounding vehicles, white lines on roads, signs, and the like.

The radar sensor 31 detects targets present around the vehicle SV. The radar sensor 31 includes a millimeter wave radar and/or a lidar. The millimeter wave radar emits radio waves in the millimeter wave band and receives millimeter waves reflected by targets present within the radiation range. The millimeter wave radar acquires the relative distance, relative speed, and other parameters between the vehicle SV and the target based on the phase difference between the transmitted millimeter wave and the received reflected wave, the attenuation level of the reflected wave, and the time from the transmission of the millimeter wave to the reception of the reflected wave. The lidar sequentially scans pulsed laser light with a wavelength shorter than the millimeter wave in a plurality of directions and receives reflected light from the target, thereby acquiring the shape of the target detected in front of the vehicle SV, as well as the relative distance, relative speed, and other parameters between the vehicle SV and the target.

The camera sensor 32 photographs the surroundings of the vehicle SV and processes the photographed image data, thereby acquiring information of targets around the vehicle SV. As the camera sensor 32, for example, a digital camera including an imaging device such as a complementary metal-oxide-semiconductor (CMOS) or a charge-coupled device (CCD) can be used. The target information is information indicating the types of targets detected around the vehicle SV, as well as the relative distance, relative speed, and other parameters between the vehicle SV and the target. The types of targets may be recognized by machine learning such as pattern matching.

The external sensor device 30 repeatedly transmits the acquired target information to the ECU 10 every time a predetermined time elapses. Note that the external sensor device 30 does not necessarily need to include both the radar sensor 31 and the camera sensor 32 and may, for example, include only the radar sensor 31 or only the camera sensor 32.

The drive device 40 generates a driving force to be transmitted to the drive wheels of the vehicle SV. Examples of the drive device 40 include an electric motor, an engine, and the like. The vehicle SV may be one of a hybrid electric vehicle, a plug-in hybrid vehicle, a fuel cell electric vehicle, a battery electric vehicle, and an engine vehicle. The steering device 41 applies a steering force to the wheels of the vehicle SV.

The brake device 50 is, for example, a disc-type brake device and applies a braking force to the wheels of the vehicle SV. The brake device 50 includes a brake actuator 51, a brake mechanism 52, and the like. The brake actuator 51 is provided in a hydraulic circuit between a master cylinder (not illustrated), which pressurizes hydraulic fluid by the stepping force of the brake pedal, and the brake mechanism 52. The brake mechanism 52 includes a brake disc 53 fixed to the wheel and a brake caliper 54 fixed to the vehicle body. The brake actuator 51 adjusts the hydraulic pressure supplied to a wheel cylinder built into the brake caliper 54 according to an instruction from the ECU 10 and activates the wheel cylinder using the hydraulic pressure. Thus, the brake actuator 51 presses the brake pad against the brake disc 53 to generate a frictional braking force. Note that the brake device 50 may be a drum-type brake device or the like.

The driver monitor device 60 is a device for acquiring the state of the driver of the vehicle SV and includes, for example, a driver camera 61. The driver camera 61 primarily captures an image of the driver's face and detects the facial orientation, gaze direction, eye-opening state, and other features of the driver. The driver monitor device 60 transmits the state of the driver (hereinafter referred to as driver state information), acquired based on the detection result of the driver camera 61, to the ECU 10 at a predetermined cycle. Note that the driver monitor device 60 is not limited to the driver camera 61 and may include other sensors that can acquire driver state information, such as a physiological measurement device that detects the driver's heart rate and pulse rate, and a seating sensor that detects the driver's seating position.

The HMI 90 is an interface for inputting and outputting information between the ECU 10 and the driver, and includes an input device and an output device. Examples of the input device include a touch panel, a switch, a sound pickup microphone, and the like. Examples of the output device include a display device 91, a speaker 92, and the like. The display device 91 is, for example, a center display, a multi-information display, a head-up display, or the like. The speaker 92 is, for example, a speaker for an audio system or a navigation system.

### Software Configuration

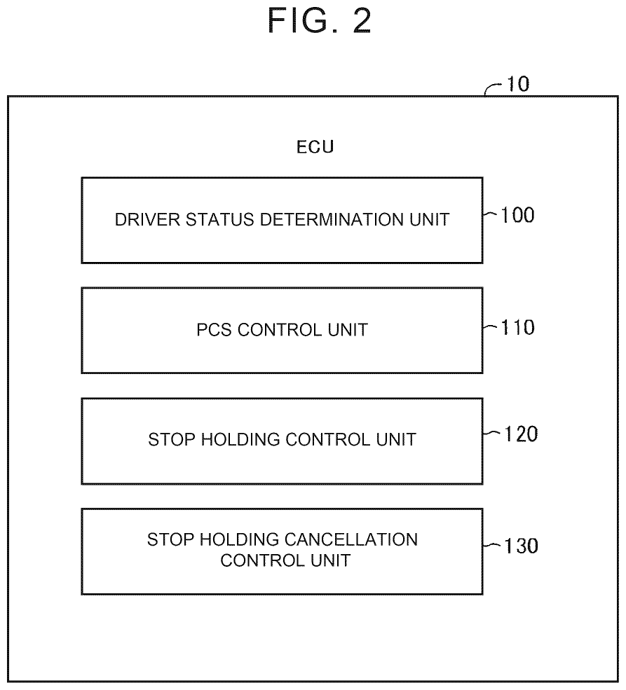

FIG. 2 is a schematic diagram illustrating the software configuration of the control device according to the present embodiment.

As illustrated in FIG. 2, the ECU 10 includes a driver status determination unit 100, a PCS control unit 110, a stop holding control unit 120, a stop holding cancellation control unit 130, and the like as functional elements. Each of the functional elements 100 to 130 is implemented by the CPU 11 of the ECU 10 reading a program stored in the ROM 12 into the RAM 13 and executing the program. Note that all or some of the functional elements 100 to 130 may be provided in another ECU separate from the ECU 10, or in an information processing device of a facility (e.g., management center) that can communicate with the vehicle SV.

The driver status determination unit 100 determines, based on the driver state information transmitted from the driver monitor device 60, whether the driver is in an abnormal state where the driver is not able to normally drive the host vehicle SV due to looking aside, dozing, confusion (panic), or the like. The driver status determination unit 100 acquires, for example, the gaze direction, eye-opening state, and other features of the driver based on the driver state information transmitted from the driver monitor device 60. The driver status determination unit 100 determines that the driver is in an abnormal state when a state where the gaze direction is outside a predetermined range including the front of vehicle SV, the driver's eyes are closed, or a similar state continues for a predetermined time. When determining that the driver is in the abnormal state, the driver status determination unit 100 transmits a “driver abnormality signal” indicating that the driver is in the abnormal state to the stop holding cancellation control unit 130 to be described later.

The PCS control unit 110 executes PCS control to avoid a collision between the host vehicle SV and a target in front or to mitigate damage from the collision. The PCS control unit 110 acquires coordinate information of an object present in front of the host vehicle SV based on the target information transmitted from the external sensor device 30. The PCS control unit 110 calculates the turning radius of the host vehicle SV based on the detection results of the vehicle speed sensor 21, the steering angle sensor 24, and the yaw rate sensor 26, and calculates the trajectory of the host vehicle SV based on the turning radius. The PCS control unit 110 determines whether a moving object and a stationary object in front of the host vehicle SV are obstacles that may collide with the host vehicle SV. When the object is a moving object, the PCS control unit 110 calculates the trajectory of the moving object based on the coordinate information of the moving object and determines that the moving object is an obstacle when the trajectory of the moving object intersects with the trajectory of the host vehicle SV. When the object is a stationary object, the PCS control unit 110 determines that the stationary object is an obstacle when the trajectory of the host vehicle SV intersects with the current position of the stationary object.

When determining that the object is an obstacle, the PCS control unit 110 calculates a predicted collision time (Time To Collision, hereinafter referred to as TTC) until the host vehicle SV collides with the obstacle, based on a distance L from the host vehicle SV to the obstacle and a relative velocity Vr of the host vehicle SV to the obstacle. TTC is an index value that indicates the likelihood of the host vehicle SV colliding with the obstacle. TTC can be obtained by dividing the distance L from the host vehicle SV to the obstacle by the relative velocity Vr (TTC=L/Vr). When TTC is equal to or less than a predetermined determination threshold, the PCS control unit 110 determines that the likelihood of the host vehicle SV colliding with the obstacle is high. When determining that the likelihood of collision is high, the PCS control unit 110 executes automatic brake control while issuing an alert with the speaker 92 and/or display device 91. The automatic brake control is controlling the actuation of the brake actuator 51 to decelerate the host vehicle SV so that the deceleration of the host vehicle SV matches a predetermined target deceleration. This enables forcible deceleration of the host vehicle SV without requiring the driver to operate the brake pedal.

When the host vehicle SV is stopped by the automatic brake control of the PCS control unit 110, the stop holding control unit 120 controls the actuation of the brake actuator 51 so that the host vehicle SV is held in a stopped state (so that the host vehicle SV neither moves forward nor backward). When confirming that the vehicle SV has been stopped by the automatic brake control, the stop holding control unit 120 controls the actuation of the brake actuator 51 and supplies the hydraulic pressure set for stop holding to the wheel cylinder of the brake mechanism 52. This holds the host vehicle SV in the stopped state. Hereinafter, holding the host vehicle SV in the stopped state is referred to as stop holding, and the braking force control that holds the host vehicle SV in the stopped state is referred to as stop holding control.

The stop holding cancellation control unit 130 determines whether a preset cancellation condition is met, and when the cancellation condition is met, terminates the stop holding control performed by the stop holding control unit 120 on the brake actuator 51. The stop holding cancellation condition is met, for example, when a duration T for which the stop holding control is performed reaches a predetermined set time Tref1. The set time Tref1 is not particularly limited, but is several seconds, for example. When the stop holding cancellation condition is met, the stop holding cancellation control unit 130 terminates the stop holding control to cancel the stop holding of the host vehicle SV.

If the stop holding control is uniformly terminated when the stop holding cancellation condition is met, that is, when the duration T for the stop holding control reaches the set time Tref1, secondary damage may occur when the driver of the host vehicle SV is in an abnormal state where the driver is not able to properly perceive surrounding information. When receiving the driver abnormality signal from the driver status determination unit 100, the stop holding cancellation control unit 130 makes it difficult for the stop holding cancellation condition to be met. Specifically, when receiving the driver abnormality signal from the driver status determination unit 100, the stop holding cancellation control unit 130 increases the set time Tref1 by a predetermined time to change the stop holding cancellation condition. Hereinafter, the changed set time is referred to as a changed set time Tref2. Therefore, when a driver abnormality occurs, the continuous execution time of the stop holding control can be extended to effectively reduce the risk of occurrence of secondary damage.

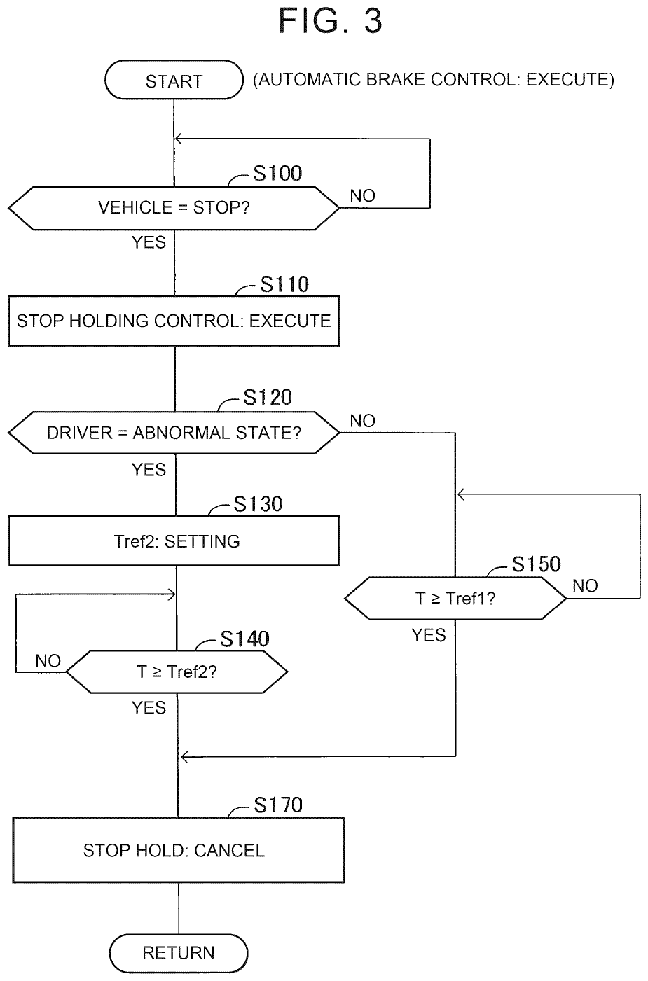

FIG. 3 is a flowchart for explaining the routine of the stop holding control and the cancellation process for the stop holding control, executed by the CPU 11 of the ECU 10. The routine illustrated in FIG. 3 starts when the automatic brake control by the PCS control is executed.

In S100, the ECU 10 determines whether the vehicle SV has been stopped by the automatic brake control by the PCS control. When the vehicle SV has been stopped (Yes), the ECU 10 proceeds to S110. On the other hand, when the vehicle SV has not stopped (No), the ECU 10 repeats the determination in S100.

In S110, the ECU 10 controls the actuation of the brake actuator 51 to execute stop holding control for holding the vehicle SV in a stopped state. Next, in S120, the ECU 10 determines whether the driver is in an abnormal state where the driver is not able to normally drive the host vehicle SV. When the driver is in the abnormal state (Yes), the ECU 10 proceeds to S130. On the other hand, when the driver is not in the abnormal state (No), the ECU 10 proceeds to S150.

In S150, the ECU 10 determines whether the duration T for which the stop holding control is performed has reached the set time Tref1. When the duration T has reached the set time Tref1 (Yes), the ECU 10 proceeds to S170. On the other hand, when the duration T has not reached the set time Tref1 (No), the ECU 10 repeats the determination in S150.

When proceeding from S120 to S130, the ECU 10 increases the set time Tref1 by a predetermined time to set the changed set time Tref2. Next, in S140, the ECU 10 determines whether the duration T for which the stop holding control is performed has reached the changed set time Tref2. When the duration T has reached the changed set time Tref2 (Yes), the ECU 10 proceeds to S170. On the other hand, when the duration T has not reached the changed set time Tref2 (No), the ECU 10 repeats the determination in S140.

In S170, the ECU 10 terminates the stop holding control, thereby cancelling the stop holding of the vehicle SV, and then returns to the start of the routine.

Although the vehicle control device according to the present embodiment has been described above, the present disclosure is not limited to the above embodiment, and various modifications are possible without departing from the purpose of the present disclosure. For example, in the above embodiment, the automatic brake control of the PCS control has been described as an example, but the technique of the present disclosure can also be applied to the cancellation of the stop holding control that is activated when the vehicle SV is stopped by the automatic brake control other than the PCS control. The technique of the present disclosure is also applicable to an autonomous vehicle in which some or all of the driving operations are performed automatically.

What is claimed is:

1. A vehicle control device comprising:
an automatic brake unit that performs automatic brake control for automatically stopping a host vehicle by applying a braking force to the host vehicle when it is determined that a predetermined automatic stop condition is met;
a stop holding unit that performs stop holding control for holding the host vehicle in a stopped state by applying a braking force to the host vehicle so that the host vehicle in a state of being stopped by the automatic brake unit does not advance or reverse;
a stop holding cancellation unit that cancels a stop holding state of the host vehicle by terminating the stop holding control when a predetermined stop holding cancellation condition is met when the stop holding control is performed by the stop holding unit; and
a driver status acquisition unit that acquires a driver status that is a status of a driver of the host vehicle, wherein the stop holding cancellation unit changes the stop holding cancellation condition according to the driver status acquired by the driver status acquisition unit.

2. The vehicle control device according to claim 1, wherein the stop holding cancellation unit makes it difficult for the stop holding cancellation condition to be met when the driver status acquisition unit acquires an indication that the driver is in an abnormal state in which the driver is not able to normally drive the host vehicle, compared to when the indication of the abnormal state is not acquired.

3. The vehicle control device according to claim 2, wherein:
the stop holding cancellation condition is met when a duration for which the stop holding control is performed reaches a predetermined time; and
the stop holding cancellation unit makes it difficult for the stop holding cancellation condition to be met by increasing the predetermined time when the driver status acquisition unit acquires the indication of the abnormal state, compared to when the indication of the abnormal state is not acquired.
